(19) United States
(12) Patent Application Publication
(10) Pub. No.: US 2014/0327373 A1
(43) Pub. Date: Nov. 6, 2014

(54) LED DRIVE DEVICE, AND LIGHTING SYSTEM INCORPORATING THE SAME

(71) Applicant: ILI TECHNOLOGY CORPORATION, Jhubei City (TW)

(72) Inventors: Wen-Kuen LIU, Jhubei City (TW); Chun-Chieh YU, Taipei City (TW)

(73) Assignee: ILI TECHNOLOGY CORPORATION, Jhubei City (TW)

(21) Appl. No.: 14/269,323

(22) Filed: May 5, 2014

(30) Foreign Application Priority Data
May 6, 2013 (TW) 102116055

(51) Int. Cl. H05B 33/08

(52) U.S. Cl. CPC H05B 33/0815
USPC 315/224

(57) ABSTRACT

An LED drive device includes: a drive module generating, based on a control signal, a drive current that flows through an LED-based load, and generating, based on the drive current, a sampling current associated with the drive current; a voltage detection module detecting a voltage across the LED-based load, and generating an adjustment signal based on the detection result and on a predetermined reference voltage; and a control signal generation module generating the control signal based on the adjustment signal, the sampling current and the predetermined reference voltage.

### CROSS-REFERENCE TO RELATED APPLICATION

This application claims priority to Taiwanese Application No. 102116055, filed on May 6, 2013, the contents of which are hereby incorporated by reference.

### BACKGROUND OF THE INVENTION

1. Field of the Invention

The invention relates to optical power control for a light emitting diode (LED), and more particularly to an LED drive device, and a lighting system incorporating the same.

2. Description of the Related Art

In recent years, LEDs have been widely applied to electronic devices, such as display devices and illumination devices, for energy-saving and environment protection purposes. LEDs employed in such electronic devices should have a stable operating power.

However, LEDs may be fabricated to have respective forward bias voltages different from a predetermined target forward bias voltage due to process drift. Thus, if a constant current flows through each of such LEDs, operating powers generated by such LEDs may not be within a desired power range. As a result, electronic products employing such LEDs may not comply with specific safety standards due to variations in the operating powers of such LEDs as induced by variations in the forward bias voltages of such LEDs. Therefore, LEDs having different forward bias voltages may be unsuitable to be directly employed in a display device or an illumination device without operating power control.

### SUMMARY OF THE INVENTION

Therefore, an object of the present invention is to provide an LED drive device, and a lighting system incorporating the same that can ensure an LED-based load to have a relatively stable operating power.

According to one aspect of the present invention, there is provided an LED drive device for generating a drive current that is adapted to flow through an LED-based load from a positive terminal of the LED-based load to a negative terminal of the LED-based load. The LED drive device of this invention comprises:

a drive module adapted to be coupled to the LED-based load, and operable to generate the drive current based on a control signal and to generate, based on the drive current, a sampling current that is associated with the drive current;

a voltage detection module operable to detect a forward bias voltage across the LED-based load and to generate an adjustment signal based on result of the detection and on a predetermined reference voltage; and

a control signal generation module coupled to the drive module and the voltage detection module for receiving the sampling current and the adjustment signal respectively therefrom, the control signal generation module being operable to generate the control signal based on the adjustment signal, the sampling current and the predetermined reference voltage, and to output the control signal to the drive module.

According to another aspect of the present invention, a lighting system comprises:

an LED-based load having opposite positive and negative terminals; and

an LED drive device for generating a drive current that flows through the LED-based load from the positive terminal to the negative terminal, the LED drive device including
a drive module coupled to the LED-based load, and operable to generate the drive current based on a control signal and to generate, based on the drive current, a sampling current that is associated with the drive current,
a voltage detection module operable to detect a forward bias voltage across the LED-based load and to generate an adjustment signal based on a detection result and on a predetermined reference voltage, and
a control signal generation module coupled to the drive module and the voltage detection module for receiving the sampling current and the adjustment signal respectively therefrom, the control signal generation module being operable to generate the control signal based on the adjustment signal, the sampling current and the predetermined reference voltage, and to output the control signal to the drive module.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic electrical circuit diagram illustrating the preferred embodiment of a lighting system according to the present invention;

FIG. 2a is an exemplary timing diagram showing a control signal present in an LED drive device of the preferred embodiment;

FIG. 2b is an exemplary timing diagram showing an operating power generated by an LED-based load of the preferred embodiment;

FIG. 3 is a schematic electrical circuit diagram illustrating the preferred embodiment when an inductor is being charged with a drive current that flows along a charging path; and

FIG. 4 is a schematic electrical circuit diagram illustrating the preferred embodiment when electric energy stored in the charged inductor is discharged to produce a drive current that flows along a discharging path.

### DETAILED DESCRIPTION OF THE PREFERRED EMBODIMENT

Before describing this invention in detail, it should be noted herein that throughout this disclosure, when two elements are described as being “coupled in series,” “connected in series” or the like, it is merely intended to portray a serial connection between the two elements without necessarily implying that the currents flowing through the two elements are identical to each other and without limiting whether or not an additional element is coupled to a common node between the two elements. Essentially, “a series connection of elements,” “a series coupling of elements” or the like as used throughout this disclosure should be interpreted as being such when looking at those elements alone.

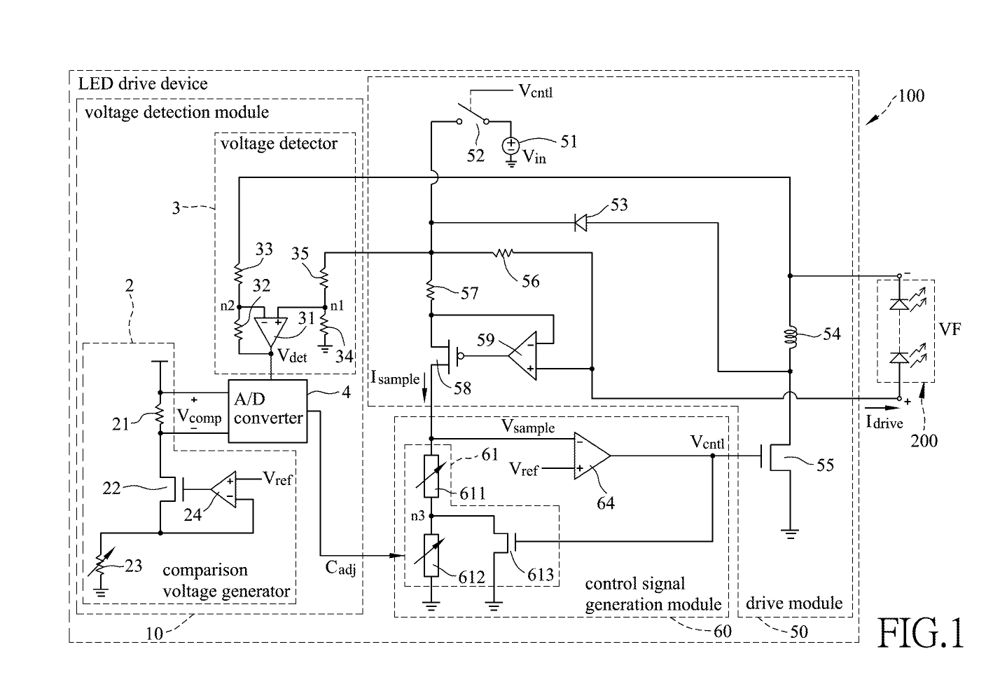

Referring to FIG. 1, the preferred embodiment of a lighting system according to the present invention is shown to include an LED-based load 200 and an LED drive module 100.

The LED-based load 200 has opposite positive and negative terminals. In this embodiment, the LED-based load 200 includes, but is not limited to, a plurality of LEDs connected in series. An anode of an endmost one of the LEDs (i.e., the lowermost one in FIG. 1) serves as the positive terminal, and a cathode of another endmost one of the LEDs (i.e., the uppermost one in FIG. 1) serves as the negative terminal.

The LED drive device 100 generates a drive current (Idrive) that flows through the LED-based load 200 from the positive terminal to the negative terminal. The LED drive device 100 includes a drive module 50, a voltage detection module 10 and a control signal generation module 60.

The drive module 50 is coupled to the LED-based load 200, and is operable to generate the drive current (Idrive) based on a control signal (Vcnt1) and to generate, based on the drive current (Idrive), a sampling current (Isample) that is associated with the drive current (Idrive). In this embodiment, the drive module 50 includes a series connection of an inductor 54, a diode 53 and a first resistor 56 coupled in parallel to the LED-based load 200, a DC voltage source 51 for supplying a DC voltage (Vin), a first switch 52, a second switch 55, a second resistor 57, a normally-conducting transistor 58 and a first operational amplifier 59. The inductor 54 is coupled between the negative terminal of the LED-based load 200 and an anode of the diode 53. The first resistor 56 is coupled between a cathode of the diode 53 and the positive terminal of the LED-based load 200. The first switch 52 is coupled between the DC voltage source 51 and the cathode of the diode 53, and has a control end for receiving the control signal (Vcnt1). The first switch 52 is operable to be conducting or non-conducting in response to the control signal (Vcnt1). The second switch 55 is coupled between the anode of the diode 53 and ground, and has a control end for receiving the control signal (Vcnt1). The second switch 55 is operable to be conducting or non-conducting in response to the control signal (Vcnt1). The second resistor 57 has opposite terminals, one of which is coupled to the cathode of the diode 53. The normally-conducting transistor 58 has a first terminal that is coupled to the other terminal of the second resistor 57, a second terminal, and a control terminal. The first operational amplifier 59 has a non-inverting input end that is coupled to the positive terminal of the LED-based load 200, an inverting input end coupled to the first terminal of the normally-conducting transistor 58, and an output end that is coupled to the control terminal of the normally-conducting transistor 58. In this embodiment, the second switch 55 is an N-type MOSFET, whose drain and source are coupled respectively to the anode of the diode 53 and ground and whose gate serves as the control end thereof. Both the first and second switches 52, 55 are conducting if the control signal (Vcnt1) has a logic high level, which serves as a first logic level, and are non-conducting if the control signal (Vcnt1) has a logic low level, which serves as a second logic level. The normally-conducting transistor 58 is a P-type MOSFET whose source, drain and gate serve respectively as the first, second and control terminals thereof. In addition, the first resistor 56 has a very small resistance (R₅₆) that is much smaller than a resistance (R₅₇) of the second resistor 57. Thus, the potential at the cathode of the diode 53 is almost similar to the potential at the positive terminal of the LED-based load 200.

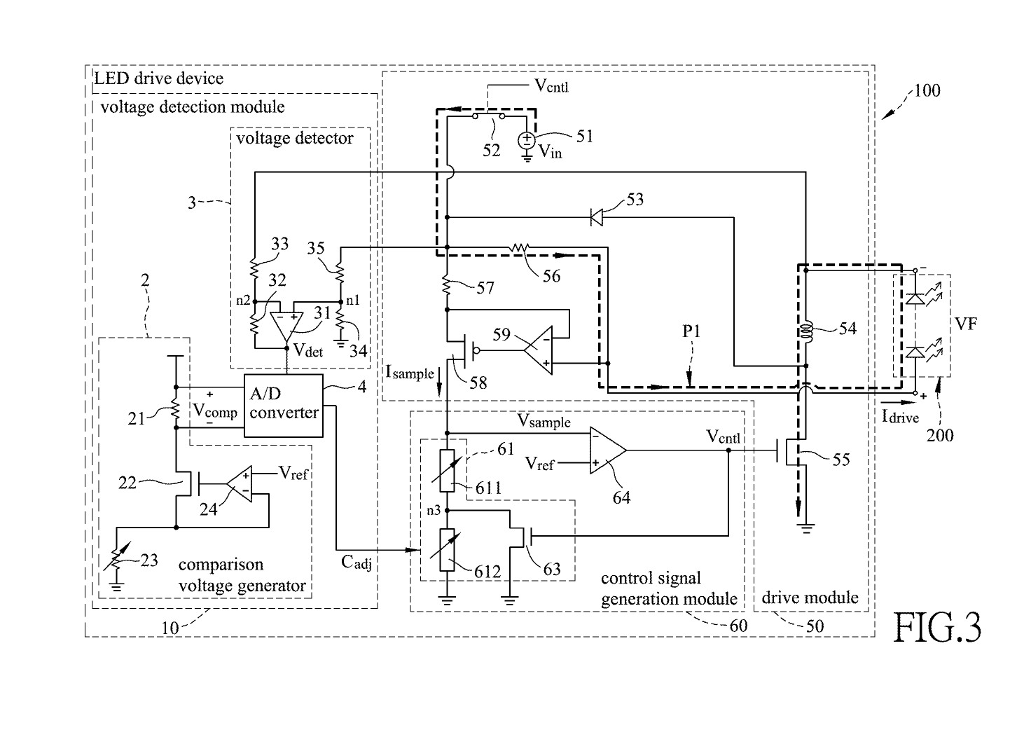

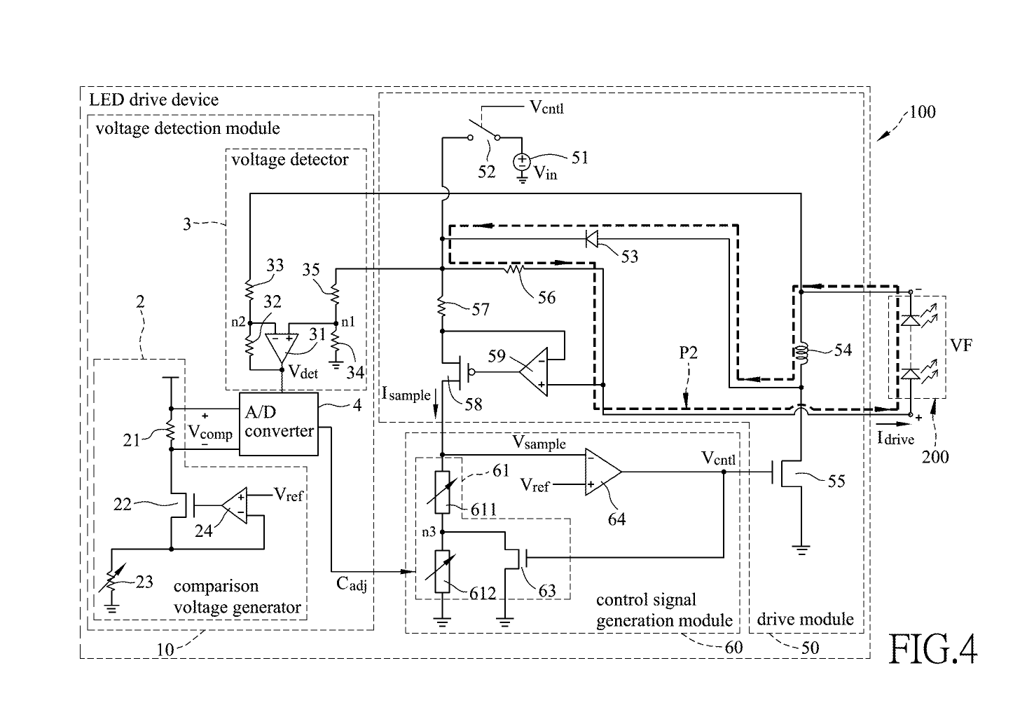

In operation, referring to FIG. 3, when the first and second switches 52, 55 are conducting, the DC voltage source 51 produces the drive current (Idrive) that flows through the first switch 52, the first resistor 56, the LED-based load 200, the inductor 54 and the second switch 55, as indicated by a dash-line path (P1) of FIG. 3, such that the LED-based load 200 is driven by the drive current (Idrive) to emit light and such that the inductor is charged with the drive current (Idrive). In addition, the DC voltage source 51 also produces the sampling current (Isample) that flows through the first switch 52, the second resistor 57 and the normally-conducting transistor 58. Referring to FIG. 4, when the first and second switches 52, 55 are non-conducting, electric energy previously stored in the inductor 54 is discharged to produce the drive current (Idrive) that flows from the inductor 54 through the diode 53, the first resistor 56 and the LED-based load 200, as indicated by a dash-line path (P2) of FIG. 4, such that the LED-based load 200 is driven by the drive current (Idrive) to emit light. Similarly, the inductor 54 also produces the sampling current (Isample) that flows through the diode 53, the second resistor 57 and the normally-conducting transistor 58. Since the non-inverting input end and the inverting input end of the first operational amplifier 59 have the same potential, the relationship between the sampling current (Isample) and the drive current (Idrive) can be represented as follows:

$$Idrive = Isample \times \frac{{R}_{57}}{{R}_{56}} \qquad Equation 1$$

Therefore, the drive current (Idrive) is positively proportional to the sampling current (Isample), and vice versa.

Referring again to FIG. 1, the voltage detection module 10 is operable to detect a forward bias voltage (VF) across the LED-based load 200 and to generate an adjustment signal (Cadj) based on result of the detection (hereinafter “a detection result”) and on a predetermined reference voltage (Vref). The voltage detection module 10 includes a comparison voltage generator 2, a voltage detector 3 and an analog-to-digital (A/D) converter 4.

The comparison voltage generator 2 is operable to generate, base on the predetermined reference voltage (Vref), a comparison voltage (Vcomp) that is associated with a target forward bias voltage of the LED-based load 200. The target forward bias voltage is positively proportional to an upper operating power limit of the LED-based load 200. In this embodiment, the comparison voltage generator 2 includes a series connection of a resistor 21, a transistor 22 and a variable resistor 23 and an operational amplifier 24. The resistor 21 is used to receive a DC bias (not shown in the Figures). The variable resistor 23 is coupled to ground. The transistor 22 has a first terminal that is coupled to the resistor 21, a second terminal that is coupled to the variable resistor 23, and a control terminal. The operational amplifier 24 has a non-inverting input end for receiving the predetermined reference voltage (Vref), an inverting input end that is coupled to the second terminal of the transistor 22, and an output end that is coupled to the control terminal of the transistor 22. In this embodiment, the transistor 22 is a normally-conducting N-type MOSFET, whose drain, source and gate serve respectively as the first, second and control terminals thereof. A voltage across the resistor 21 is outputted as the comparison voltage (Vcomp). Since the non-inverting input end and the inverting input end of the operational amplifier 24 have the same potential identical to the predetermined reference voltage (Vref), the comparison voltage (Vcomp) can be represented as follows:

$$Vcomp = Vref \times \frac{{R}_{21}}{{R}_{23}} \qquad Equation 2$$

where R₂₁ and R₂₃ represent respectively resistances of the resistor 21 and the variable resistor 23. It is noted that the resistance (R₂₃) of the variable resistor 23 is adjusted in a manner that the comparison voltage (Vcomp) corresponds to the target forward bias voltage. For example, if the upper operating power limit of the LED-based load 200 increases, i.e., the target forward bias voltage of the LED-based load 200 increases, the comparison voltage (Vcomp) increases with increase of the target forward bias voltage. It is known from Equation 2 that the resistance (R₂₃) of the variable resistor 23 decreases with increase of the comparison voltage (Vcomp).

The voltage detector 3 is operable to detect the forward bias voltage (VF) so as to generate, based on the detection result, a detection voltage (Vdet) that is associated with the forward bias voltage (VF). In this embodiment, the voltage detector 3 includes a series connection of a third resistor 32 and a fourth resistor 33, a series connection of a fifth resistor 34 and a sixth resistor 35, and a second operational amplifier 31. The fourth resistor 33 is coupled to the negative terminal of the LED-based load 200. The fifth and sixth resistors 34, 35 are coupled respectively to ground and the cathode of the diode 53 of the drive module 50. The second operational amplifier 31 has a non-inverting input end that is coupled to a first common node (n1) between the fifth and sixth resistors 34, 35, an inverting input end that is coupled to a second common node (n2) between the third and fourth resistors 32, 33, and an output end that is coupled to the A/D converter 4 for outputting the detection voltage (Vdet). It is noted that the third and fifth resistors 32, 34 have the same resistance, i.e., R₃₂=R₃₄, and the fourth and sixth resistors 33, 35 have the same resistance, i.e., R₃₃=R₃₅. In addition, the first and second common nodes (n1, n2) have the same potential, and the potential at the cathode of the diode 53 is almost similar to the potential at the positive terminal of the LED-based load 200. Therefore, the detection voltage (Vdet) can be represented as follows:

$$V det = VF \times \frac{{R}_{32}}{{R}_{33}} \qquad Equation 3$$

The A/D converter 4 is coupled to the output end of the second operational amplifier 31 of the voltage detector 3 and the comparison voltage generator 2 for receiving the detection voltage (Vdet) and the comparison voltage (Vcomp) respectively therefrom. The A/D converter 4 is operable to convert a difference between the detection voltage (Vdet) and the comparison voltage (Vcomp) into a digital signal, for example, an N-bit code, where N≧2. The digital signal serves as the adjustment signal (Cadj). It is noted that the adjustment signal (Cadj) has a magnitude that increases/decreases with increase/decrease of the detection voltage (Vdet). It is known from Equation 3 that the magnitude of the adjustment signal (Cadj) increases/decreases with increase/decreases of the forward bias voltage (VF), accordingly.

Referring again to FIG. 1, the control signal generation module 60 is coupled to the drive module 50 and the voltage detection module 10 for receiving the sampling current (Isample) and the adjustment signal (Cadj) respectively therefrom. The control signal generation module 60 is operable to generate the control signal (Vcnt1) based on the adjustment signal (Cadj), the sampling current (Isample) and the predetermined reference voltage (Vref). In this embodiment, the control signal generation module 60 includes a variable resistor unit 61 and a comparator 64.

The variable resistor unit 61 is coupled to the second terminal of the normally-conducting transistor 58 of the drive module 50 for permitting the sampling current (Isample) from the second terminal of the normally-conducting transistor 58 to flow therethrough. The variable resistor unit 61 has a first control end that is coupled to the A/D converter 4 of the voltage detection module 10 for receiving the adjustment signal (Cadj) therefrom, and a second control end for receiving the control signal (Vcnt1). The variable resistor unit 61 is operable based on the adjustment signal (Cadj) and the control signal (Vcnt1) to have a resistance (R₆₁) that increases/decreases with increase/decrease of the magnitude of the adjustment signal (Cadj). In this embodiment, the variable resistor unit 61 includes, but is not limited to, a first variable resistor module 611 coupled to the second terminal of the normally-conducting transistor 58, a second variable resistor module 612 coupled between the first variable resistor module 611 and ground, and a transistor 613, such as an N-type MOSFET, coupled between ground and a third common node (n3) between the first and second variable resistor modules 611, 612. The transistor 613 has a gate that serves as the second control end of the variable resistor unit 61, such that the transistor 613 is operable to be conducting or non-conducting in response to the control signal (Vcnt1). It is noted that, for example, each of the first and second variable resistor modules 611, 612 may be controlled by the adjustment signal (Cadj) to have a resistance (R₆₁₁, R₆₁₂) that increases/decreases with increase/decrease of the magnitude of the adjustment signal (Cadj). Therefore, when the transistor 613 is non-conducting, the resistance (R₆₁) of the chargeable resistor unit 61 is equal to a sum of the resistances (R₆₁₁, R₆₁₂) of the first and second variable resistor modules 611, 612, i.e., R₆₁=R₆₁₁+R₆₁₂; and when the transistor 613 is conducting, R₆₁=R₆₁₁.

The comparator 64 has a non-inverting input end for receiving the predetermined reference voltage (Vref), an inverting input end that is coupled to the second terminal of the normally-conducting transistor 58 for receiving a voltage across the chargeable resistor unit 61 as a sampling voltage (Vsample), and an output end that is coupled to the control ends of the first and second switches 51, 55 of the drive module 50, and to the gate of the transistor 63 (i.e., the second control end of the variable resistor unit 61). The sampling voltage (Vsample) can be represented as follows:

Vsample=Isample×R₆₁ Equation 4

The comparator 64 compares the sampling voltage (Vsample) and the predetermined reference voltage (Vref) so as to generate, based on result of the comparison (hereinafter “a comparison result”), the control signal (Vcnt1) that is outputted at the output end thereof.

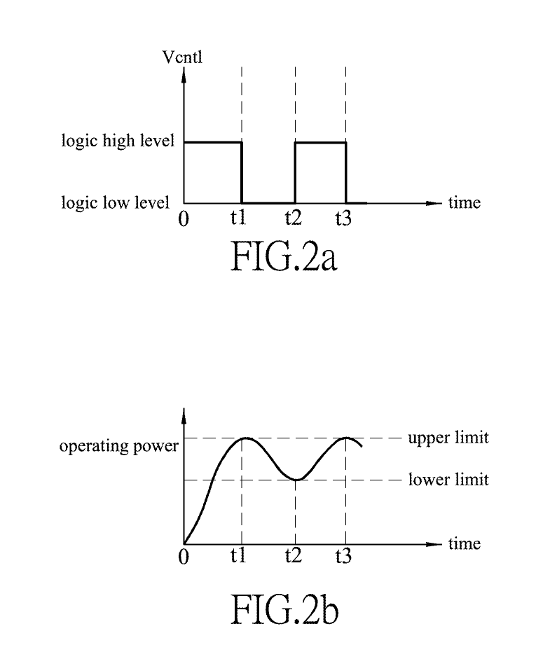

In operation under an ideal condition, where the forward bias voltage (VF) of the LED-based load 200 is maintained at the target forward bias voltage, referring further FIGS. 2a, 2b, 3 and 4, when the sampling voltage (Vsample) is smaller than the predetermined reference voltage (Vref), the control signal (Vcnt1) has the logic high level. In this case, the first and second switches 51, 55 and the transistor 613 conduct, and Vsample=Isample×R₆₁₁. Thus, the drive current (Idrive), which flows along the path (P1) of FIG. 3 and is provided by the drive module 50 to the LED-based load 200, gradually increases within a duration of the control signal (Vcnt1) being at the logic high level, for example, a period from time 0 to time t1 or from time t2 to time t3 of FIG. 2a. Accordingly, based on Equation 1, the sampling current (Isample) gradually increases until the sampling voltage (Vsample) is greater than the reference voltage (Vref), at which time the control signal (Vcnt1) becomes the logic low level. As a result, the operating power of the LED-based load 200 gradually increases to reach an upper limit during the period from time 0 to time t1 or from time t2 to time t3, as shown in FIG. 2b. When the control signal (Vcnt1) becomes the logic low level, the first and second switches 51, 55 and the transistor 613 become non-conducting and Vsample=Isample×(R₆₁₁+R₆₁₂). Thus, the drive current (Idrive), which flows along the path (P2) of FIG. 4 and is provided by the drive module 50 to the LED-based load 200, gradually decreases within a duration of the control signal (Vcnt1) being at the logic low level, for example, a period from time t1 to time t2 of FIG. 2a. In this case, it is known from Equation 1 that the sampling current (Isample) gradually decreases until the sampling voltage (Vsample) is less than the reference voltage (Vref), at which time the control signal (Vcnt1) switches from the logic low level to the logic high level. As a result, the operating power of the LED-based load 200 gradually decreases from the upper limit to a lower limit. Since the control signal (Vcnt1) changes between the logic high level and the logic low level, the operating power of the LED-based load 200 ideally changes between the upper limit and the lower limit.

However, in actual use, the forward bias voltage (VF) of the LED-based load 200 may deviate from the target forward bias voltage to a greater or smaller voltage as a result of process drift and/or ambient temperature variations. Therefore, this invention uses the voltage detection module 10 to detect the actual forward bias voltage (VF) of the LED-based load 200 to generate the adjustment signal (Cadj). For example, during the control signal (Vcnt1) being at the logic high level, if the voltage detection module 10 detects that the forward bias voltage (VF) of the LED-based load 200 becomes greater than the target forward bias voltage, the adjustment signal (Cadj) generated by the voltage detection module 10 has an increased magnitude. Accordingly, the resistance (R₆₁) of the variable resistor unit 61 increases. In this case, it is known from Equation 4 that with the increasing resistance (R₆₁), when the sampling voltage (Vsample) is close to but smaller than the reference voltage (Vref), the sampling current (Isample) decreases, and the drive current (Idrive) decreases according to Equation 1. Therefore, the operating power of the LED-based load 200 does not exceed the upper limit even though the forward bias voltage (VF) increases. Similarly, during the control signal (Vcnt1) being at the logic low level, if the voltage detection module 10 detects that the forward bias voltage (VF) of the LED-based load 200 becomes smaller than the target forward bias voltage, i.e., the forward bias voltage (VF) of the LED-based load 200 decreases from the target forward bias voltage, the adjustment signal (adj) generated by the voltage detection module 10 has a decreased magnitude. Accordingly, the resistance (R₆₁) of the variable resistor unit 61 decreases. In this case, it is known from Equation 4 that with the decreasing resistance (R₆₁), when the sampling voltage (Vsample) is close to but greater than the reference voltage (Vref), the sampling current (Isample) increases, and the drive current (Idrive) increases accordingly. Therefore, the operating power of the LED-based load 200 is not smaller than the lower limit even though the forward bias voltage (VF) decreases. As a result, the operating power of the LED-based load 200 stably changes between the upper limit and the lower limit.

In sum, due to the presence of the voltage detection module 10 and the variable resistor unit 61 of the LED drive device 100, the lighting system 200 of this invention can ensure the LED-based load 200 to have a relatively stable operating power without affection by variations of the forward bias voltage (VF) of the LED-based load 200.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light emitting diode (LED) drive device for generating a drive current that is adapted to flow through an LED-based load from a positive terminal of the LED-based load to a negative terminal of the LED-based load, said LED drive device comprising:
a drive module adapted to be coupled to the LED-based load, and operable to generate the drive current based on a control signal and to generate, based on the drive current, a sampling current that is associated with the drive current;
a voltage detection module operable to detect a forward bias voltage across the LED-based load and to generate an adjustment signal based on result of the detection and on a predetermined reference voltage; and
a control signal generation module coupled to said drive module and said voltage detection module for receiving the sampling current and the adjustment signal respectively therefrom, said control signal generation module being operable to generate the control signal based on the adjustment signal, the sampling current and the predetermined reference voltage, and to output the control signal to said drive module.

2. The LED drive device as claimed in claim 1, wherein:
the sampling current is positively proportional to the drive current; and
the control signal changes between a first logic level and a second logic level, the drive current gradually increasing within a duration of the control signal being at the first logic level, and gradually decreasing within a duration of the control signal being at the second logic level.

3. The LED drive device as claimed in claim 2, wherein said voltage detection module includes:
a comparison voltage generator for generating, based on the predetermined reference voltage, a comparison voltage that is associated with a target forward bias voltage of the LED-based load;
a voltage detector adapted for detecting the forward bias voltage so as to generate, based on the result of the detection, a detection voltage that is associated with the forward bias voltage; and
an analog-to-digital converter coupled to said comparison voltage generator and said voltage detector for receiving the comparison voltage and the detection voltage respectively therefrom, said analog-to-digital converter being operable to convert a difference between the detection voltage and the comparison voltage into a digital signal that serves as the adjustment signal, the adjustment signal having a magnitude that increases/decreases with increase/decrease of the detection voltage.

4. The LED drive device as claimed in claim 3, wherein said comparison voltage generator of said voltage detection module includes
a series connection of a resistor, a transistor and a variable resistor, said resistor being used to receive a DC bias, said variable resistor being coupled to ground, said transistor having a first terminal that is coupled to said resistor, a second terminal that is coupled to said variable resistor, and a control terminal, and
an operational amplifier having a non-inverting input end for receiving the predetermined reference voltage, an inverting input end that is coupled to said second terminal of said transistor, and an output end that is coupled to said control terminal of said transistor; and
wherein a voltage across said resistor is outputted as the comparison voltage, and said variable resistor is adjusted in a manner that the comparison voltage corresponds to the target forward bias voltage.

5. The LED drive device as claimed in claim 3, wherein said drive module includes
a series connection of an inductor, a diode and a first resistor adapted to be coupled in parallel to the LED-based load, said inductor being coupled between the negative terminal of the LED-based load and an anode of said diode, said first resistor being coupled between the positive terminal of the LED-based load and a cathode of said diode,
a DC voltage source for supplying a DC voltage;
a first switch coupled between said DC voltage source and said cathode of said diode, said first switch having a control end for receiving the control signal and being operable to be conducting or non-conducting in response to the control signal,
a second switch coupled between said anode of said diode and ground, said second switch having a control end for receiving the control signal and being operable to be conducting or non-conducting in response to the control signal,
a second resistor having opposite terminals, one of which is coupled to said cathode of said diode,
a normally-conducting transistor having a first terminal that is coupled to the other one of said terminals of said second resistor, a second terminal, and a control terminal, and
a first operational amplifier having a non-inverting input end that is adapted to be coupled to the positive terminal of the LED-based load, an inverting input end that is coupled to said first terminal of said normally-conducting transistor, and an output end that is coupled to said control terminal of said normally-conducting transistor;
wherein, when said first and second switches are conducting, said DC voltage source produces the drive current that flows through said first switch, said first resistor, the LED-based load, said inductor and said second switch, such that said inductor is charged with the drive current; and
wherein, when said first and second switches are non-conducting, electric energy previously stored in said inductor is discharged to produce the drive current that flows from said inductor through said diode, said first resistor and the LED-based load; and
wherein the sampling current is a current flowing through said second resistor and said normally-conducting transistor.

6. The LED drive device as claimed in claim 5, wherein said voltage detector of said voltage detection module includes
a series connection of a third resistor and a fourth resistor, said fourth resistor being adapted to be coupled to the negative terminal of the LED-based load,
a series connection of a fifth resistor and a sixth resistor, said fifth and sixth resistor being coupled respectively to ground and said cathode of said diode of said drive module, and
a second operational amplifier having a non-inverting input end that is coupled to a first common node between said fifth and sixth resistors, an inverting input end that is coupled to a second common node between said third and fourth resistors, and an output end that is coupled to said analog-to-digital converter for outputting the detection voltage.

7. The LED drive device as claimed in claim 6, wherein:
for said drive module, said first resistor has a resistance that is much smaller than a resistance of said second resistor; and
for said voltage detector of said voltage detection module, said third and fifth resistors have the same resistance, said fourth and sixth resistors have the same resistance, and the detection voltage is substantially proportional to the forward bias voltage.

8. The LED drive device as claimed in claim 5, wherein said control signal generation module includes:
a variable resistor unit coupled to said second terminal of said normally-conducting transistor of said drive module for permitting the sampling current from said second terminal of said normally-conducting transistor to flow therethrough, said variable resistor unit having a first control end that is coupled to said analog-to-digital converter of said voltage detection module for receiving the adjustment signal therefrom, and a second control end for receiving the control signal, said variable resistor unit being operable based on the adjustment signal and the control signal received thereby to have a resistance that increases/decreases with increase/decrease of the magnitude of the adjustment signal; and
a comparator having non-inverting and inverting input ends, one of which receives the predetermined reference voltage and the other one of which is coupled to said second terminal of said normally-conducting transistor for receiving a voltage across said variable resistor unit as a sampling voltage, and an output end that is coupled to said control ends of said first and second switches of said drive module and to said second control end of said variable resistor unit, said comparator comparing the sampling voltage and the predetermined reference voltage so as to generate, based on result of the comparison, the control signal that is outputted at said output end thereof.

9. The LED drive device as claimed in claim 8, wherein said variable resistor unit of said control signal generation module includes
a first variable resistor module coupled to said second terminal of said normally-conducting transistor of said drive module, said first variable resistor module being controlled by the adjustment signal to have a resistance that increases/decreases with increase/decrease of the magnitude of the adjustment signal,
a second variable resistor module coupled between said first variable resistor module and ground, said second variable resistor module being controlled by the adjustment signal to have a resistance that increases/decreases with increase/decrease of the magnitude of the adjustment signal, and
a transistor coupled between ground and a third common node between said first and second variable resistor modules, said transistor having a control terminal that serves as said second control end of said variable resistor unit such that said transistor is operable to be conducting or non-conducting in response to the control signal; and
wherein said variable resistor unit has a resistance that is equal to a resistance of said first variable resistor module when said transistor is conducting, or to a sum of the resistance of said first variable resistor module and a resistance of said second variable resistor module when said transistor is non-conducting.

10. The LED drive device as claimed in claim 9, wherein the control signal has the first logic level when the sampling voltage is less than the predetermined reference voltage, and said control signal has the second logic level when the sampling voltage is greater than the predetermined reference voltage.

11. The LED drive device as claimed in claim 10, wherein:
said non-inverting input end of said comparator of said control signal generation module receives the predetermined reference voltage, and said inverting input end of said comparator is coupled to said second terminal of said normally-conducting transistor of said drive module;
the first and second logic levels are respectively a logic high level and a logic low level; and
each of said transistor of said control signal generation module and said second switch of said drive module is an N-type MOSFET.

12. A lighting system comprising:
an LED-based load having opposite positive and negative terminals; and
an LED drive device for generating a drive current that flows through said LED-based load from said positive terminal to said negative terminal, said LED drive device including
a drive module coupled to said LED-based load, and operable to generate the drive current based on a control signal and to generate, based on the drive current, a sampling current that is associated with the drive current,
a voltage detection module operable to detect a forward bias voltage across said LED-based load and to generate an adjustment signal based on result of the detection and on a predetermined reference voltage, and
a control signal generation module coupled to said drive module and said voltage detection module for receiving the sampling current and the adjustment signal respectively therefrom, said control signal generation module being operable to generate the control signal based on the adjustment signal, the sampling current and the predetermined reference voltage, and to output the control signal to said drive module.

13. The lighting system as claimed in claim 12, wherein:
the sampling current is positively proportional to the drive current; and
the control signal changes between a first logic level and a second logic level, the drive current gradually increasing within a duration of the control signal being at the first logic level, and gradually decreasing within a duration of the control signal being at the second logic level.

14. The lighting system as claimed in claim 13, wherein said voltage detection module of said voltage detection module of said LED drive device includes:
a comparison voltage generator for generating, based on the predetermined reference voltage, a comparison voltage that is associated with a target forward bias voltage of said LED-based load;
a voltage detector for detecting the forward bias voltage so as to generate, based on the result of the detection, a detection voltage that is associated with the forward bias voltage; and
an analog-to-digital converter coupled to said comparison voltage generator and said voltage detector for receiving the comparison voltage and the detection voltage respectively therefrom, said analog-to-digital converter being operable to convert a difference between the detection voltage and the comparison voltage into a digital signal that serves as the adjustment signal, the adjustment signal having a magnitude that increases/decreases with increase/decrease of the detection voltage.

15. The lighting system as claimed in claim 14, wherein said comparison voltage generator of said voltage detection module of said LED drive device includes
a series connection of a resistor, a transistor and a variable resistor, said resistor being used to receive a DC bias, said variable resistor being coupled to ground, said transistor having a first terminal that is coupled to said resistor, a second terminal that is coupled to said variable resistor, and a control terminal, and
an operational amplifier having a non-inverting input end for receiving the predetermined reference voltage, an inverting input end that is coupled to said second terminal of said transistor, and an output end that is coupled to said control terminal of said transistor; and
wherein a voltage across said resistor is outputted as the comparison voltage, and said variable resistor is adjusted in a manner that the comparison voltage corresponds to the target forward bias voltage.

16. The lighting system as claimed in claim 14, wherein said drive module of said LED drive device includes
a series connection of an inductor, a diode and a first resistor coupled in parallel to said LED-based load, said inductor being coupled between said negative terminal of said LED-based load and an anode of said diode, said first resistor being coupled between said positive terminal of said LED-based load and a cathode of said diode,
a DC voltage source for supplying a DC voltage;
a first switch coupled between said DC voltage source and said cathode of said diode, said first switch having a control end for receiving the control signal and being operable to be conducting or non-conducting in response to the control signal,
a second switch coupled between said anode of said diode and ground, said second switch having a control end for receiving the control signal and being operable to be conducting or non-conducting in response to the control signal,
a second resistor having opposite terminals, one of which is coupled to said cathode of said diode,
a normally-conducting transistor having a first terminal that is coupled to the other one of said terminals of said second resistor, a second terminal, and a control terminal, and
a first operational amplifier having a non-inverting input end that is coupled to said positive terminal of said LED-based load, an inverting input end that is coupled to said first terminal of said normally-conducting transistor, and an output end that is coupled to said control terminal of said normally-conducting transistor;
wherein, when said first and second switches are conducting, said DC voltage source produces the drive current that flows through said first switch, said first resistor, said LED-based load, said inductor and said second switch, such that said inductor is charged with the drive current; and
wherein, when said first and second switches are non-conducting, electric energy previously stored in said inductor is discharged to produce the drive current that flows from said inductor through said diode, said first resistor and said LED-based load; and
wherein the sampling current is a current flowing through said second resistor and said normally-conducting transistor.

17. The lighting system as claimed in claim 16, wherein said voltage detector of said voltage detection module of said LED drive device includes
a series connection of a third resistor and a fourth resistor, said third resistor being coupled to said negative terminal of said LED-based load,
a series connection of a fifth resistor and a sixth resistor, said fifth and sixth resistor being coupled respectively to ground and said cathode of said diode of said drive module, and
a second operational amplifier having a non-inverting input end that is coupled to a first common node between said fifth and sixth resistors, an inverting input end that is coupled to a second common node between said third and fourth resistors, and an output end that is coupled to said analog-to-digital converter for outputting the detection voltage.

18. The lighting system as claimed in claim 17, wherein:
for said drive module of said LED drive device, said first resistor has a resistance that is much smaller than a resistance of said second resistor; and
for said voltage detector of said voltage detection module of said LED drive device, said third and fifth resistors have the same resistance, said fourth and sixth resistors have the same resistance, and the detection voltage is substantially proportional to the forward bias voltage.

19. The lighting system as claimed in claim 16, wherein said control signal generation module of said LED drive device includes:
a variable resistor unit coupled to said second terminal of said normally-conducting transistor of said drive module for permitting the sampling current from said second terminal of said normally-conducting transistor to flow therethrough, said variable resistor unit having a first control end that is coupled to said analog-to-digital converter of said voltage detection module for receiving the adjustment signal therefrom, and a second control end for receiving the control signal, said variable resistor unit being operable based on the adjustment signal and the control signal received thereby to have a resistance that increases/decreases with increase/decrease of the magnitude of the adjustment signal; and
a comparator having non-inverting and inverting input ends, one of which receives the predetermined reference voltage and the other one of which is coupled to said second terminal of said normally-conducting transistor for receiving a voltage across said variable resistor unit as a sampling voltage, and an output end that is coupled to said control ends of said first and second switches of said drive module and to said second control end of said variable resistor unit, said comparator comparing the sampling voltage and the predetermined reference voltage so as to generate, based on result of the comparison, the control signal that is outputted at said output end thereof.

20. The lighting system as claimed in claim 19, wherein said variable resistor unit of said control signal generation module of said LED drive device includes
a first variable resistor module coupled to said second terminal of said normally-conducting transistor of said drive module, said first variable resistor module being controlled by the adjustment signal to have a resistance that increases/decreases with increase/decrease of the magnitude of the adjustment signal,
a second variable resistor module coupled between said first variable resistor module and ground, said second variable resistor module being controlled by the adjustment signal to have a resistance that increases/decreases with increase/decrease of the magnitude of the adjustment signal, and
a transistor coupled between ground a third common node between said first and second variable resistor modules, said transistor having a control terminal that serves as said second control end of said variable resistor unit such that said transistor is operable to be conducting or non-conducting in response to the control signal; and
wherein said variable resistor unit has a resistance that is equal to a resistance of said first variable resistor module when said transistor is conducting, or to a sum of the resistance of said first variable resistor module and a resistance of said second variable resistor module when said transistor is non-conducting.

21. The lighting system as claimed in claim 20, wherein the control signal has the first logic level when the sampling voltage is smaller than the predetermined reference voltage, and the control signal has the second logic level when the sampling voltage is greater than the predetermined reference voltage.

22. The lighting system as claimed in claim 21, wherein, for said LED drive device:
said non-inverting input end of said comparator of said control signal generation module receives the predetermined reference voltage, and said inverting input end of said comparator is coupled to said second terminal of said normally-conducting transistor of said drive module;
the first and second logic levels are respectively a logic high level and a logic low level; and
each of said transistor of said control signal generation module and said second switch of said drive module is an N-type MOSFET.
